(19) United States
(12) Patent Application Publication
(10) Pub. No.: US 2019/0266323 A1
(43) Pub. Date: Aug. 29, 2019

(54) IDENTIFICATION PROCESS FOR SUSPICIOUS ACTIVITY PATTERNS BASED ON ANCESTRY RELATIONSHIP

(71) Applicant: CrowdStrike, Inc., Irvine, CA (US)

(72) Inventors: Cory-Khoi Quang Nguyen, Lafayette, IN (US); Brody Nisbet, Newcastle (AU); John Lee, Cleveland, OH (US)

(21) Appl. No.: 16/168,588

(22) Filed: Oct. 23, 2018

Related U.S. Application Data
(60) Provisional application No. 62/634,408, filed on Feb. 23, 2018.

(51) Int. Cl. G06F 21/55; G06F 21/56; G06F 11/30; H04L 29/06

(52) U.S. Cl. CPC G06F 21/552; G06F 21/566; G06F 11/3072; G06F 11/3006; H04L 63/1416; H04L 63/1441; H04L 63/1425

(57) ABSTRACT

A security service system and method for using a process based on ancestry relationship as a pattern for identifying a suspicious activity, such as a possible malicious attack or malware, are described herein. The security service system identifies a trigger command in a process running on a monitored computing device, identifies an ancestry command associated with the trigger command, determines an ancestry level of the ancestry command, and upon determining that the ancestry level of the ancestry command is different from an expected ancestry level of the ancestry command for the trigger command, identify a pattern based on the trigger command, the ancestry command, and the ancestry level of the ancestry command.

### RELATED APPLICATION

This patent application claims priority to U.S. Provisional Application No. 62/634,408 titled “Computer Security,” filed on Feb. 23, 2018, commonly assigned herewith, and hereby incorporated by reference.

### BACKGROUND

With Internet use forming an ever greater part of day to day life, security exploits that steal or destroy system resources, data, and private information are an increasing problem. Governments and businesses devote significant resources to preventing intrusions and thefts related to these security exploits. Security exploits come in many forms, such as computer viruses, worms, trojan horses, spyware, keystroke loggers, adware, and rootkits. These exploits are delivered in or through a number of mechanisms, such as spearfish emails, clickable links, documents, executables, or archives. Some of the threats posed by security exploits are of such significance that they are described as cyber terrorism or industrial espionage.

To meet the threats posed by these security exploits, a number of tools capable of retrospective analysis of system performance and state have been developed. For example, the BackTracker tool described in “Backtracking Intrusions” by Samuel T. King and Peter M. Chen (ACM SIGOPS Operating Systems Review—SOSP '03, Volume 37, Issue 5, December 2003, pgs. 223-236) automatically identifies potential sequences of steps that occurred in an intrusion by analyzing a comprehensive log of system activities and data. While such tools can detect security exploits and their manners of operation, they can only operate retrospectively and thus place those attacked at a disadvantage, always one step behind the attacker. Further, these techniques typically operate only on records of a single device, and thus lack the context of activities occurring on other devices, which may be important in determining whether novel or unusual behavior is suspect.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example network connecting an adversary system initiating a suspicious process, a computing device affected by that process, and a security service system configured to identify and/or respond to the process.

FIG. 2 illustrates an example block diagram of the security service system.

FIG. 3 illustrates an example process for identifying a suspicious activity.

FIG. 4 illustrates an example process detailing one of blocks of FIG. 3 for identifying a previously unknown pattern.

FIG. 5 illustrates an example process detailing one of blocks of FIG. 4.

FIG. 6 illustrates an example additional process to the process of FIG. 4.

### DETAILED DESCRIPTION

### Overview

This disclosure describes, in part, a method and system for using a process based on ancestry relationship for identifying or detecting a suspicious activity such as a possible malicious attack or malware.

Examples of such system components include processes and modules, and examples of events include identifying a specific command, which may be referred as a trigger command, an associated command spawning the trigger command, which may be referred as an ancestry command, and a number of command steps between the ancestry command and the trigger command, which may be referred as an ancestry level. In other words, a trigger command is a particular generation descendent of an associated ancestry command, where the particular generation is equal to the ancestry level. One ancestry command may be associated with one or more trigger commands at more than one ancestry levels. Similarly, one trigger command may be associated with one or more ancestry commands at more than one ancestry levels. An administrative status of a user running the process having these events may also be considered. A relationship among such events, and potentially coupled with the administrative status of the user, may be evaluated to recognize a pattern as a suspicious activity. The pattern may then be applied to other processes running on a monitored computing device to identify possible malicious activities.

An agent may reside on each of the monitored computing devices and may output events, such as a trigger command, an ancestry command, and an ancestry level, to a security service server, or cloud, which may be remote from the monitored computing device. The security service server receives those output events and, in substantially real-time, may analyze the output events, and identify a pattern. The security service server may then monitor for the pattern in processes running on the monitored computing devices, statistically analyze the processes identified with the pattern, and identify suspicion activities running on the monitored computing devices.

### Example Network

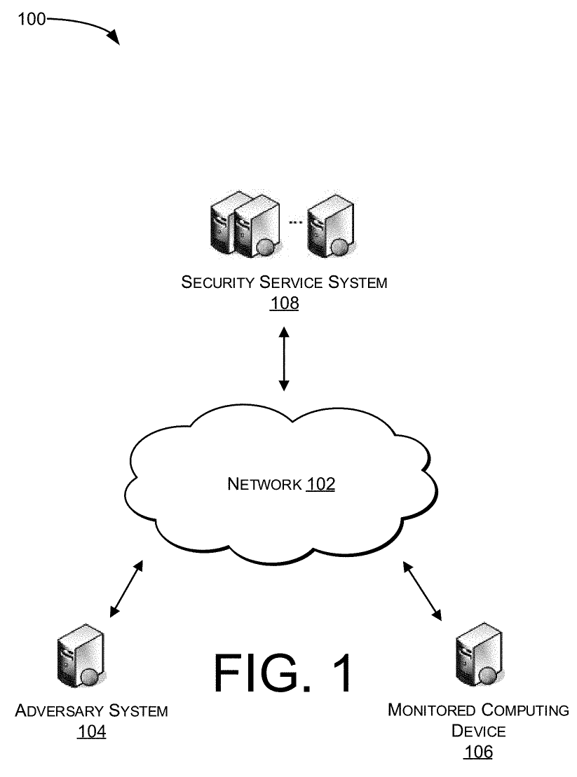

FIG. 1 illustrates an example environment 100 with a network 102 connecting an adversary system 104 which has initiated a suspicious activity, a monitored computing device 106 running the suspicious activity, and a security service system 108 configured to identify, monitor, and/or respond to the suspicious activity.

The security service system 108 may be local system or a distributed system such as a cloud computing, and may comprise a plurality of security service devices, may monitor and receive security-relevant information from the monitored computing device 106, which may be one of a plurality of monitored computing devices, via the network 102. The monitored computing device 106 may be part of a group, such as a customer or other entity, which may connect the monitored computing device 106 to the network 102 and to other monitored computing devices. The monitored computing device 106 may be a single device, a plurality of devices, or a cloud device distributed over the network 102. The monitored computing device 106 may be configured with an agent which may provide events that include security-relevant information to the security service system 108. The security service system 108 may in turn analyze the events, determine whether the process running on the monitored computing device 106 associated with the events is suspicious, and identify a suspicious pattern from analyzing the events. The security service system 108 may then monitor for the suspicious pattern in other processes running on the monitored computing device 106 to determine if any of the other processes are suspicious.

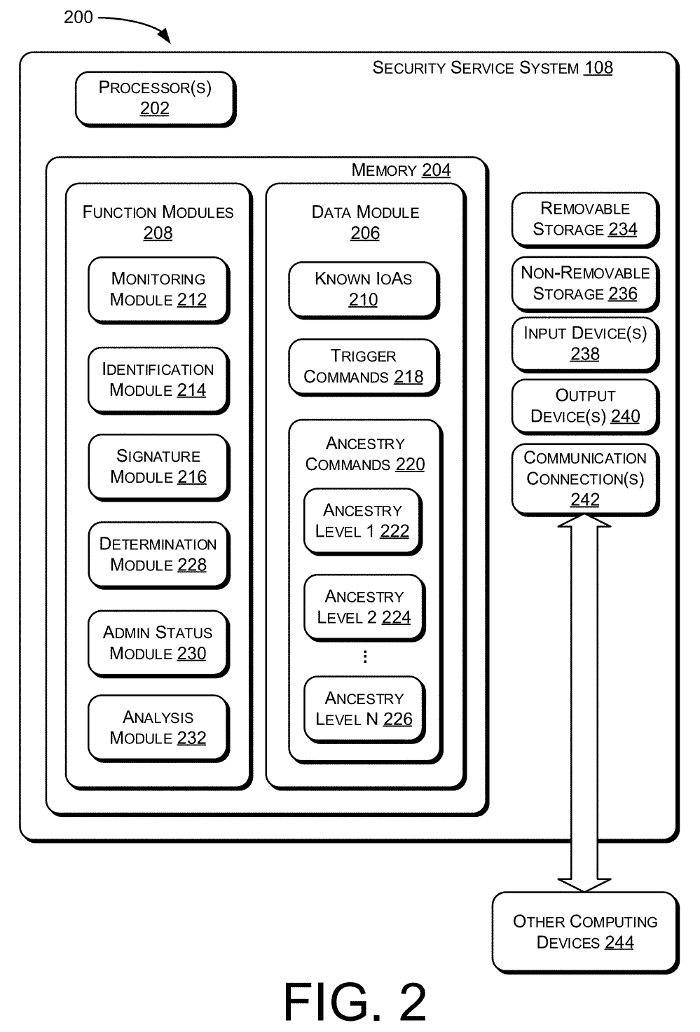

The devices implementing the security service system 108 may each be or include a server or server farm, multiple, distributed server farms, a mainframe, a work station, a personal computer (PC), a laptop computer, a tablet computer, a personal digital assistant (PDA), a cellular phone, a media center, an embedded system, or any other sort of device or devices. In one implementation, the devices implementing the security service system 108 represent a plurality of computing devices working in communication, such as a cloud computing network of nodes. When implemented on multiple computing devices, the security service system 108 may distribute modules and data, further described with reference to FIG. 2 below of the security service system 108 among the multiple computing devices. In some implementations, one or more of the devices implementing the security service system 108 represent one or more virtual machines implemented on one or more computing devices.

In some embodiments, the monitored computing device 106 may each be a server or server farm, multiple, distributed server farms, a mainframe, a work station, a PC, a laptop computer, a tablet computer, a PDA, a cellular phone, a media center, an embedded system, or any other sort of device or devices. When implemented on multiple computing devices, a monitored computing device 106 may distribute the agent among the multiple computing devices. In some implementations, a monitored computing device 106 represents one or more virtual machines implemented on one or more computing devices.

In various embodiments, the network 102 may include any one or more networks, such as wired networks, wireless networks, and combinations of wired and wireless networks. Further, the network 102 may include any one or combination of multiple different types of public or private networks (e.g., cable networks, the Internet, wireless networks, etc.). In some instances, computing devices communicate over the network 102 using a secure protocol (e.g., https) and/or any other protocol or set of protocols, such as the transmission control protocol/Internet protocol (TCP/IP).

In some embodiments, the monitored computing device 106 may be connected to the security service system 108 via a secure channel, such as a virtual private network (VPN) tunnel or other sort of secure channel and may provide events conveying security-relevant information to the security service system 108 through the secure channel. The agent on the monitored computing device 106 may also receive configuration updates, instructions, remediation, etc. from the security service system 108 via the secure channel.

### Example Security Service System

FIG. 2 illustrates an example block diagram 200 of the security service system 108 for identifying a possible malicious or suspicious activity. The security service system 108 may comprise one or more processors (processor(s)) 202 and a memory module 204 that is communicatively coupled to the processor(s) 202. The memory 204 may comprise a data module 206 and function modules 208 including various function modules that are communicatively coupled to each other and are executable by the processor(s) 202.

The data module 206 may be configured to store data, locally or in a cloud storage, known IoAs 210, such as historically collected or previous encountered suspicious activity patterns. The data module 206 may store data in various formats, such as SQL, NoSQL, encrypted, unencrypted, hashed, and the like. The function module 208 may comprise a monitoring module 212 configured to receive monitored data in a process running on a monitored computing device, such as the monitored computing device 106, and an identification module 214 configured to identify one or more IoAs based on a comparison between the received monitored data and the known IoAs 210. The function module 208 may further comprise a signature module 216 configured to generate a signature based on one or more IoAs identified by the identification module 214.

To identify a previously unknown suspicious activity pattern, the identification module 214 may be further configured to identify a trigger command by searching for the trigger command in the received monitored data. The trigger command is a command known to be associated with suspicious activities that may be running on the monitored computing device 106, and may be selected from a plurality of preselected trigger commands 218 stored in the data module 206 in the memory 204, such as “whoami,” “taskkill,” “nbtstat,” “net/localgroup,” “reg/add,” and the like. The identification module 214 may also be configured to identify an ancestry command associated with the trigger command. The ancestry command is a command known to spawn the trigger command at a certain level. For example, an ancestry command “cmd.exe” may be known, or expected to be, a parent command of, i.e. one level prior to, the trigger command “whoami”, and may be selected from a plurality of preselected ancestry commands 220 stored in the data module 206. Ancestry commands for a specific trigger command may be grouped based on expected levels of ancestry, or ancestry levels, from the specific trigger command, and may include different ancestry commands based on the ancestry level. Example ancestry commands based on the ancestry levels 1, 2, and N are illustrated as Ancestry Level 1 222, Ancestry Level 2 224, and Ancestry Level N 226, in FIG. 2.

The function modules 208 may also comprise a determination module 228 that is configured to determine an ancestry level of the ancestry command identified by the identification module 214. For example, for the trigger command “whoami,” the determination module 228 may determine an ancestry level of the ancestry command “cmd.exe” identified by the identification module 214 to be two, or a grandparent. Because the ancestry command “cmd.exe” is known, or expected, to be a parent—not a grandparent—of the trigger command “whoami,” the determination module 228 recognizes that the ancestry level is different from an expected ancestry level, which may be considered as a new IoA. The data module 206 may then store the new IoA as a part of the known IoAs 210. The identification module 214 may be further configured to identify a suspicious pattern based on the trigger command, the ancestry command, and the ancestry level of the ancestry command that is found to be unexpected by the determination module 228 as described above.

The function modules 208 may additionally comprise an administrative status module 230 that is configured to determine an administrative status of a user associated with the process running on the monitored computing device 106. The administrative status of the user may indicate types of processes he may likely run. For example, a user who is an administrator of the monitored computing device 106, or the network 102, may legitimately initiate and run certain processes that would be unusual for an ordinary user. The administrative status module 230 may assign different weight factors to different administrative statuses of users. The identification module 214 may identify one or more suspicious activity patterns based, additionally in part, on the administrative status and a corresponding weight of the user associated with the process running on the monitored computing device 108. Examples are discussed herein, e.g., with reference to block 504.

To identify other suspicious activities, the function modules 208 may additionally comprise an analysis module 232 that is configured to analyze all process trees in a plurality of connections within a specific environment belonging to the monitored computing device 106. Based on the analysis, the analysis module 232 may identify a process tree having a number of command lines less than a threshold number as a suspicious activity, statistically analyze all the process trees for frequency of the new suspicious activity pattern, and identify process tress having the frequency lower than a threshold frequency as malicious or suspicious activities. More common occurrences, i.e., the frequency being higher than the threshold, may generally be considered to be benign.

Example processes are illustrated below.

For a “whoami” process, the security service system 108 may look up the parent and grandparent processes, apply regexes to the file names, file paths, and command lines of the parent and grandparent processes, and exit the pattern if these fields contained expected values. Otherwise, the security service system 108 may determine that the pattern as suspicious.

For a “powershell” process, the security service system 108 may check the ancestry, up to the great-grandparent level, looking for suspicious ancestors. For example, if a productivity application, such as Microsoft® Word, or an Internet information service (IIS) exists as an ancestor, the security service system 108 may trigger a detection identifying the process as suspicious. The severity of this detection can vary depending on the type of initial target process and the nature of the suspicious ancestor.

For a “net” process, the security service system 108 may look up the grandparent process. For the SHA256 hash of the grandparent process' primary module, the security service system 108 may compute prevalence data across customer and/or global scope. If the hash has low prevalence, for example, it has only been seen at one customer and on less than 3 hosts at that customer, then the security service system 108 may trigger a detection identifying the process as suspicious. For the file name and/or command line of the grandparent, the security service system 108 may compute the prevalence of the values of these fields in the context of their occurrence in a grandparent of the initial “net” process. In other words, without being concerned with the prevalence of the file name and/or command line of the grandparent process per se, the security service system 108 may evaluate how often this file name and/or command line occurs in a process when it is a grandparent of “net”. If the prevalence is low, the security service system 108 may trigger a detection identifying the process as suspicious. The security service system 108 may look up metadata on the grandparent process, specifically, whether it wrote a PE file, made a DNS request, made a network connection, or wrote an ASEP. If so, the security service system 108 may trigger a detection identifying the process as suspicious. Alternatively, for the metadata, the security service system 108 may compute prevalence on selected fields (for example, prevalence of the SHA256 hash of the PE that was written, or prevalence of the domain contained in the DNS request). If the prevalence of these fields is low across customer scope and/or global scope, the security service system 108 may trigger a detection identifying the process as suspicious.

For a set of two or more kinds of processes (for example, “cat” and “whoami”), whether the parent and/or grandparent of these processes are shared (i.e., whether the initial processes are siblings or cousins) may be determined, and if so, the security service system 108 may trigger a detection identifying the process as suspicious.

The security service system 108 may additionally include a removable storage 234 and non-removable storage 236, input device(s) 238, output device(s) 240, and communication connections 242 for communicating with other computing devices 244.

In various embodiments, the memory 204 may be volatile (such as RAM), non-volatile (such as ROM, flash memory, etc.) or some combination of the two. The data module 206 or the function modules 208 stored in the memory 204 may comprise methods, threads, processes, applications or any other sort of executable instructions, such as the instructions utilized to perform operations of the security service system 108 in conjunction with other devices of the security service system 108 (in examples in which the security service system 108 includes multiple devices). The data module 206 and the function modules 208 may also include files and databases.

In some embodiments, the processor(s) 202 is a central processing unit (CPU), a graphics processing unit (GPU), or both CPU and GPU, or other processing unit or component known in the art.

The security service system 108 may also include additional data storage devices (removable and/or non-removable) such as, for example, magnetic disks, optical disks, or tape. Such additional storage is illustrated in FIG. 2 by removable storage 234 and non-removable storage 236. Non-transitory computer-readable media may include volatile and nonvolatile, removable and non-removable media implemented in any method or technology for storage of information. The memory 204, removable storage 234 and non-removable storage 236 are all examples of computer-readable storage media. Non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other physical, tangible medium which can be used to store the desired information and which can be accessed by the security service system 108. Any such non-transitory computer-readable media may be part of the security service system 108.

The security service system 108 may also have input device(s) 238, such as a keyboard, a mouse, a touch-sensitive display, voice input device, etc., and output device(s) 240 such as a display, speakers, a printer, etc. These devices are well known in the art and need not be discussed at length here.

The security service system 108 may also contain communication connections 242 that allow the security service system 108 to communicate with other computing devices 244, such as any or all of the monitored computing devices 104.

### Example Processes

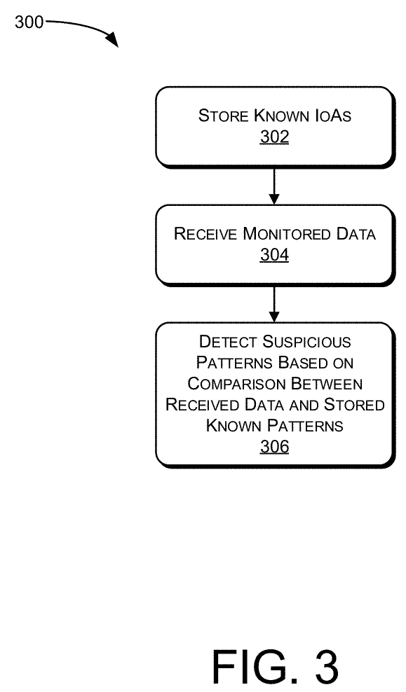

FIGS. 3-6 illustrate example processes 300, 400, 500, and 600, respectively. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

FIG. 3 illustrates an example process 300 for identifying a suspicious activity pattern. At block 302, the security service system 108 may store known suspicious activity patterns or known IoAs in the data module 206 as described above with reference to FIG. 2. For example, the known suspicious activity patterns and/or known IoAs may be stored locally or in a cloud storage in various formats, such as SQL, NoSQL, encrypted, unencrypted, hashed, and the like.

At block 304, the security service system 108 may receive, from the monitoring module 212, monitored data in a process running on a monitored computing device, such as the monitored computing device 106.

At block 306, the security service system 108 may identify one or more suspicious activity patterns or IoAs. Block 306 can include comparing the received monitored data and the known more suspicious activity patterns or IoAs, and identifying the suspicious activity patterns or IoAs based at least in part on the results of the comparison.

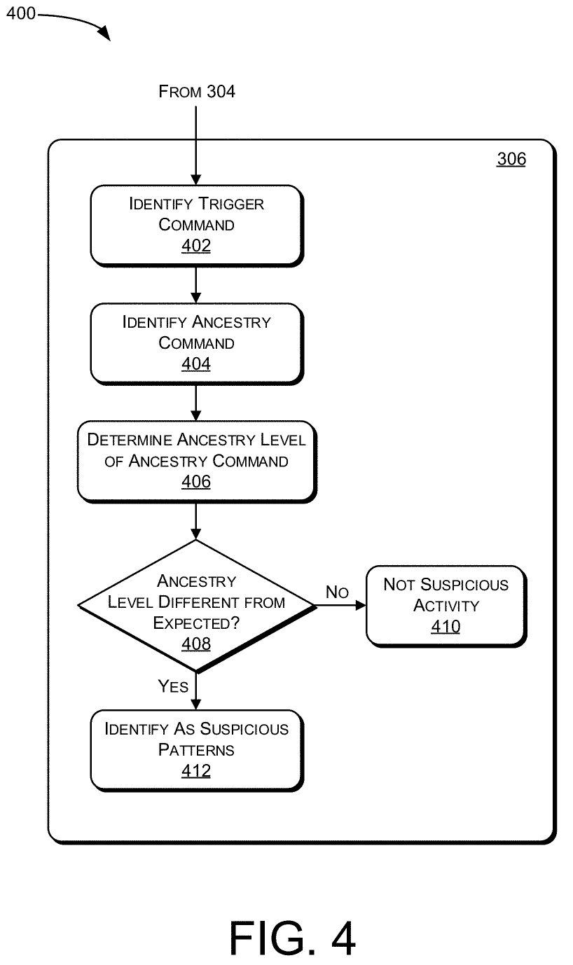

FIG. 4 illustrates an example process 400 detailing block 306 for identifying a previously unknown IoA. At block 402, the security service system 108 may identify a trigger command, such as “whoami” in a process running on a monitored device, such as the monitored computing device 106 as discussed above with reference to FIG. 2, by searching for the trigger command in the received monitored data. As discussed above, the trigger command is a command known to potentially be associated with suspicious activities that may be running on the monitored computing device 106 and may be selected from a plurality of preselected trigger commands, such as “whoami,” “taskkill,” “nbtstat,” “net/localgroup,” “reg/add,” and the like. The security service system 108 may then identify, at block 404, an ancestry command of the trigger command “whoami,” such as “cmd.exe” and determine an ancestry level of the ancestry command at block 406.

The ancestry command is a command known to spawn the trigger command at a certain level. For example, an ancestry command “cmd.exe” may be known or expected to be a parent command of, i.e. one level prior to, the trigger command “whoami”, and may be selected from a plurality of preselected ancestry commands. Ancestry commands for a specific trigger command may be grouped based on expected levels of ancestry, or ancestry levels, from the specific trigger command, and may include different ancestry commands based on the ancestry level. At block 408, the security service system 108 may determine whether the ancestry level of the ancestry command is different from an expected ancestry level of the ancestry command for the trigger command.

If the ancestry level of the ancestry command matches (is not different from) an expected ancestry level, then the security service system 108 determines that there is no suspicious activity (block 410). For example, if the ancestry command “cmd.exe” were detected as a parent of the trigger command “whoami,” then the ancestry level would be one, which the expected level of the ancestry command “cmd.exe” for the trigger command “whoami.” However, if the ancestry level of the ancestry command is different from an expected ancestry level, for example, the ancestry command “cmd.exe” being detected as a grandparent of the trigger command “whoami”, making the ancestry level to be two instead of the expected ancestry level of one, then the trigger command, the ancestry command, and the ancestry level of the ancestry command may be identified as a suspicious activity at block 412.

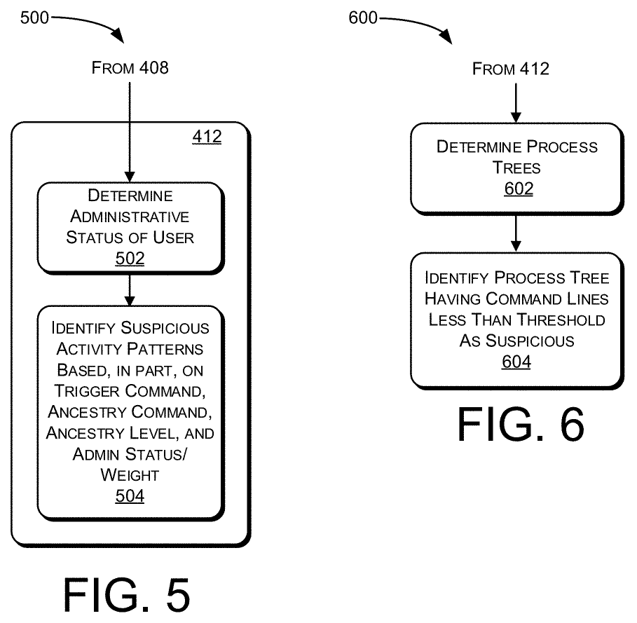

FIG. 5 illustrates an example process 500 detailing block 412 of FIG. 4. At block 502, an administrative status of a user, which may be a person or a device, associated with the process running on the monitored computing device 106, may be determined. The administrative status of the user may be determined based on an identify of the user, a user credential associated with the process running on the monitored device, allowed users on the monitored device, and the like. The administrative status of the user may indicate types of processes he may likely run. For example, a user who is an administrator of the monitored computing device 106, or the network 102, may legitimately initiate and run certain processes that would be unusual for a plain user. At block 504, a weight factor, which may be pre-determined, based on the administrative status, may be additionally considered for identifying the suspicious activity patterns. For example, each suspicious activity pattern currently identified may be assigned a severity level. A currently identified suspicious activity pattern with a severity level exceeding a predetermined threshold may be used as basis for identifying as a suspicious activity pattern. However, the severity level may be reduced by the weight factor of the user, such that the currently identified suspicious activity pattern with the severity level exceeding the predetermined threshold may be reduced below the predetermined threshold if the user were an administrator.

FIG. 6 illustrates an example additional process 600 to the process of FIG. 4. At block 602, process trees in a plurality of connections within a specific environment belonging to the monitored computing device 106 are determined, and, at block 604, a process tree having a number of command lines less than a threshold number as a suspicious activity. The process tree may be statistically analyzed for frequency of the new suspicious activity pattern, and may be identified as a suspicious activity if the frequency is lower than a threshold number frequency.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A security service system for identifying a suspicious activity, the security service comprising:
one or more processors; and
memory coupled to the one or more processors, the memory including a plurality of modules communicatively coupled to each other and executable by the one or more processors, the plurality of modules comprising:
a data module configured to store known patterns, the known patterns including known suspicious activity patterns and known indicators of attack (IoAs);
a monitoring module configured to receive monitored data in a process running on a monitored computing device; and
an identification module configured to identify one or more suspicious activity patterns based on a comparison between the received monitored data and the known patterns.

2. A security service system of claim 1, wherein:
the plurality of modules further comprises a determination module configured to determine an ancestry level of an ancestry command and to determine whether the ancestry level of the ancestry command is different from an expected ancestry level of the ancestry command for a trigger command,
the identification module is further configured to identify the trigger command in the process running on the monitored computing device and to identify the ancestry command associated with the trigger command, and
the data module is further configured to store information associated with the trigger command, the ancestry command, and the ancestry level of the ancestry command as a new suspicious activity pattern.

3. A security service system of claim 2, wherein:
the trigger command is a trigger command of a plurality of preselected trigger commands, and
the ancestry command is an ancestry command of a plurality of preselected ancestry commands associated with the trigger command.

4. A security service system of claim 3, wherein the plurality of preselected ancestry commands is associated with the trigger command for the expected ancestry level.

5. A security service system of claim 4, wherein the plurality of the preselected ancestry commands is different from a plurality of preselected ancestry commands for a second ancestry level that is associated with the trigger command and that is different from the expected ancestry level.

6. A security service system of claim 2, wherein:
the plurality of modules further comprises an administrative status module configured to determine an administrative status of a user associated with the process running on the monitored computing device.

7. A security service system of claim 6, wherein the identification module is further configured to identify the one or more suspicious activity patterns based, in part, on a weight factor associated with the administrative status of the user.

8. A security service system of claim 2, wherein the plurality of modules further comprises an analysis module configured to:
determine a plurality of process trees in a plurality of connections within a specific environment to which the monitored computing device belongs,
identify a process tree of the plurality of process trees having a number of command lines less than a threshold number as a suspicious activity,
statistically analyze the process tree of the plurality of process trees for frequency of the new suspicious activity pattern; and
identify the process tree as a suspicious activity if the frequency is lower than a threshold frequency.

9. A method for detecting a suspicious activity, the method comprising, at a security service system:
storing known patterns, the known patterns including known suspicious activity patterns and known indicators of attack (IoAs);
receiving monitored data in a process running on a monitored computing device; and
identifying one or more suspicious activity patterns based on a comparison between the received monitored data and the known patterns.

10. A method of claim 9, further comprising:
identifying a trigger command in the process running on the monitored computing device;
identifying an ancestry command associated with the trigger command;
determining an ancestry level of the ancestry command; and
upon determining that the ancestry level of the ancestry command is different from an expected ancestry level of the ancestry command for the trigger command, storing information associated with the trigger command, the ancestry command, and the ancestry level of the ancestry command as a new suspicious activity pattern.

11. A method of claim 10,
wherein the trigger command is a trigger command of a plurality of preselected trigger commands, and
wherein the ancestry command is an ancestry command of a plurality of preselected ancestry commands associated with the trigger command.

12. A method of claim 11, wherein the plurality of preselected ancestry commands is associated with the trigger command for the expected ancestry level.

13. A method of claim 12, wherein the plurality of the preselected ancestry commands comprises a different set of ancestry commands from a plurality of preselected ancestry commands for a different ancestry level associated with the trigger command.

14. A method of claim 10, further comprising:
determining an administrative status of a user associated with the process running on the monitored computing device.

15. A method of claim 14, wherein identifying the one or more suspicious activity patterns is based, in part, on a weight factor associated with the administrative status of the user.

16. A method of claim 10, further comprising:
determining a plurality of process trees in a plurality of connections within a specific environment to which the monitored computing device belongs; and
identifying a process tree of the plurality of process tress having a number of command lines less than a threshold number as a suspicious activity.

17. A method of claim 16, wherein identifying the process tree as the suspicious activity comprises:
statistically analyzing the process tree for frequency of the new suspicious activity pattern; and
identifying the process tree as a suspicious activity if the frequency is lower than a threshold frequency.

18. Non-transitory computer-readable media having stored thereon a plurality of programming instructions which, when executed by one or more computing devices, cause the one or more computing devices to perform operations comprising:
storing known patterns, the known patterns including known suspicious activity patterns and known indicators of attack (IoAs);
receiving monitored data in a process running on a monitored computing device; and
identifying one or more suspicious activity patterns based on a comparison between the received monitored data and the known patterns.

19. Non-transitory computer-readable media of claim 18, wherein the operations further comprise:
identifying a trigger command in the process running on the monitored computing device;
identifying an ancestry command associated with the trigger command;
determining an ancestry level of the ancestry command; and
upon determining that the ancestry level of the ancestry command is different from an expected ancestry level of the ancestry command for the trigger command, storing information associated with the trigger command, the ancestry command, and the ancestry level of the ancestry command as a new suspicious activity pattern.

20. Non-transitory computer-readable media of claim 19,
wherein the trigger command is a trigger command of a plurality of preselected trigger commands, and
wherein the ancestry command is an ancestry command of a plurality of preselected ancestry commands associated with the trigger command.

21. Non-transitory computer-readable media of claim 19, wherein the plurality of preselected ancestry commands is associated with the trigger command for the ancestry level and is different from a plurality of preselected ancestry commands for a second ancestry level that is associated with the trigger command and that is different from the expected ancestry level.

22. Non-transitory computer-readable media of claim 19, wherein the operations further comprise:
determining an administrative status of a user associated with the process running on the monitored computing device,
wherein identifying the one or more suspicious activity patterns is based, in part, on the administrative status of the user associated with the process running on the monitored computing device, the administrative status having a weight factor.

23. Non-transitory computer-readable media of claim 19, wherein the operations further comprise:
determining a plurality of process trees in a plurality of connections within a specific environment to which the monitored computing device belongs;
identifying a process tree of the plurality of process trees having a number of command lines less than a threshold number as a suspicious activity; and
statistically analyzing the process tree for frequency of the new suspicious activity pattern; and
identifying the process tree as a suspicious activity if the frequency is lower than a threshold frequency.
